(19) United States
(12) Patent Application Publication
(10) Pub. No.: US 2014/0216203 A1
(43) Pub. Date: Aug. 7, 2014

(54) FUEL SUPPLY PUMP

(71) Applicant: DENSO CORPORATION, Kariya-city (JP)

(72) Inventor: Satoru TAKAMIZAWA, Obu-city (JP)

(73) Assignee: DENSO CORPORATION, Kariya-city (JP)

(21) Appl. No.: 14/172,235

(22) Filed: Feb. 4, 2014

(30) Foreign Application Priority Data
Feb. 7, 2013 (JP) 2013-21871

(51) Int. Cl. F16H 25/08

(52) U.S. Cl. CPC F16H 25/08
USPC 74/569

(57) ABSTRACT

A tappet converts rotational motion of a cam placed on a lower side of a plunger into linear reciprocating motion and transmits the converted linear reciprocating motion to the plunger. The tappet includes a roller and a shoe. The roller is reciprocated in a top-to-bottom direction in a state where the roller contacts an outer peripheral surface of the cam. The shoe rotatably supports the roller and is reciprocated in the top-to-bottom direction. In the fuel supply pump, there is satisfied an inequality of X<r. In this inequality, X denotes a distance between a top-dead center and a bottom-dead center of the plunger in the top-to-bottom direction, and r denotes a radius of the roller.

### CROSS REFERENCE TO RELATED APPLICATION

This application is based on and incorporates herein by reference Japanese Patent Application No. 2013-021871 filed on Feb. 7, 2013.

### TECHNICAL FIELD

The present disclosure relates to a fuel supply pump.

### BACKGROUND

A previously known fuel supply pump pressurizes fuel to a high pressure of more than 100 MPa and discharges the pressurized fuel. Such a fuel supply pump is used in, for example, a fuel supply system that supplies the fuel to an internal combustion engine through an accumulator that stores the fuel in the high pressure state.

One type of previously known fuel supply pump includes a plunger and a tappet. The plunger forms a pressurizing chamber of fuel. The tappet transmits a drive force, which is generated through rotation of a cam, to the plunger. The plunger is reciprocated in a top-to-bottom direction by the tappet to increase or decrease a volume of the pressurizing chamber. For example, JP2010-505058A (corresponding to US2010/0037865A1) teaches the tappet that includes a roller and a shoe. The roller contacts an outer peripheral surface of the cam. The roller is reciprocated in the top- to-bottom direction while the roller rotates along the outer peripheral surface of the cam. The shoe rotatably supports the roller and is reciprocated in the top-to-bottom direction. The fuel supply pump is formed as an inline pump that has a plurality of pump units, each of which includes the plunger, the cam and the tappet, and these pump units are arranged one after another in an axial direction of the camshaft.

Furthermore, in the fuel supply pump of JP2010-505058A (corresponding to US2010/0037865A1), the shoe has a slide surface, which is configured into a cylindrical form and slidably contacts the cylindrical surface of the roller such that the slide surface of the shoe rotatably supports the roller. In a cross section, which is perpendicular to a rotational axis of the roller, the slide surface of the shoe forms an arc, which is arcuately curved about the rotational axis of the roller and has a radius that is generally the same as a radius of the roller. In the following discussion, the arc of the slide surface in the cross section, which is perpendicular to the rotational axis of the roller, will be also referred to as a slidably contacting arc. The slide surface of the shoe is formed such that a central angle of the slidably contacting arc is larger than 180 degrees. Thereby, the slide surface of the shoe extends on the upper side (top side) and the lower side (bottom side) of the rotational axis of the roller. In a case where the tappet is fastened to a housing (i.e., the tappet being stuck to the housing) and is stopped in a top dead center, the roller can be rotatably supported by a lower region of the slide surface of the shoe, which is located on the lower side of the rotational axis of the roller, so that falling down of the roller from the slide surface of the shoe is prevented.

Specifically, as shown in FIGS. 5A and 5B, when the roller falls down from the shoe, the roller may be excessively decentered (see FIG. 5A) and/or turned (see FIG. 5B). At that time, a corner of the roller may possibly contact the inner wall of the housing. In such a case, it is conceivable that the roller is stuck in a space defined by the housing, the cam and the shoe to disable rotation of the camshaft, thereby possibly resulting in stopping of the internal combustion engine.

In view of the above point, the slide surface of the shoe is made such that the central angle of the slidably contacting arc is larger than 180 degrees, and thereby the roller is rotatably supported by the slide surface of the shoe on the lower side of the rotational axis of the roller to prevent the falling down of the roller.

In the case of the fuel supply pump recited in JP2010-505058A (corresponding to US2010/0037865A1), there is an increasing demand for reducing costs of a material of the shoe.

Specifically, the shoe 100 may possibly be formed in a manner shown in FIGS. 6A and 6B to meet the demand of processing the slide surface 101 of the shoe 100 for the low costs and the high precision. That is, the material 102 of the shoe 100 is processed to form a cylindrical inner peripheral surface 103, to which the roller is fitted, at the high precision (see FIG. 6A). Thereafter, the material 102 is cut into two portions 102a, 102b (see FIG. 6B).

At this time, the material 102 is cut such that the central axis 104 of the inner peripheral surface 103 is included in the portion 102a selected from the two portions 102a, 102b. Thereby, the central angle of the slidably contacting arc of the portion 102a becomes larger than 180 degrees, and this portion 102a is finished as the shoe 100. As a result, the portion 102b, which does not include the central axis 104, has the central angle of the slidably contacting arc, which is less than 180 degrees. Thus, for the purpose of preventing the falling down of the roller, the portion 102b may not be used as the shoe and may be wasted.

In order to address this disadvantage, for example, as shown in FIGS. 6C and 6D, the material 102 may be equally divided into the two portions 102a, 102b such that a cut surface 105 between the portions 102a, 102b includes the central axis 104. In this way, the portions 102a, 102b are configured into the same shape, and the central angle of the slidably contacting arc of each of the portions 102a, 102b becomes generally 180 degrees.

There is the increased demand for reducing the costs by changing the cutting location of material 102 in the manner discussed above, thereby eliminating the waste of the material 102.

In this case, it is necessary to take additional measures to limit the falling down of the roller, such as the measures recited in DE102009056304A1. Specifically, in DE102009056304A1, two holding elements (also referred to as holding means), which limit falling down of the roller, are placed on the lower side of the roller and directly contact the roller.

However, according to DE102009056304A1, the holding elements are installed to the roller after the fitting of the roller to the shoe. Therefore, the cylindrical surface of the roller may possibly be damaged by the holding elements. Furthermore, for example, metal burrs may possibly be caught between the holding elements and the roller. In addition, the holding elements may possibly limit a flow of lubricating oil into a gap between the cylindrical surface of the roller and the slide surface of the shoe to possibly cause lubrication failure.

Therefore, it has been demanded to provide measures that can avoid stopping of the internal combustion engine by enabling rotation of the camshaft even upon falling down of the roller rather than directly limiting the falling down of the roller.

### SUMMARY

The present disclosure is made in view of the above points.

According to the present disclosure, there is provided a fuel supply pump, which includes a plunger, a tappet and a partially cylindrical surface. The plunger forms a pressurizing chamber of fuel and is reciprocated in a top-to-bottom direction to increase or decrease a volume of the pressurizing chamber. The tappet is a mechanism, which converts rotational motion of a cam placed on a lower side of the plunger into linear reciprocating motion and transmits the converted linear reciprocating motion to the plunger. The tappet includes a roller and a shoe. The roller is configured into a cylindrical form. The roller is reciprocated in the top-to-bottom direction in a state where the roller contacts an outer peripheral surface of the cam and rotates along the outer peripheral surface of the cam. The shoe rotatably supports the roller and is reciprocated in the top-to-bottom direction. The partially cylindrical surface is a slide surface, which is formed in the shoe and slidably contacts a cylindrical surface of the roller from an upper side of the roller to rotatably support the roller. In a cross section, which is perpendicular to a rotational axis of the roller, the partially cylindrical surface forms an arc, which is arcuately curved about the rotational axis of the roller and has a radius that is generally the same as a radius of the roller, and the arc is placed on an upper side of the rotational axis of the roller. There is satisfied a first relationship that is an inequality of X<r. In this inequality, X denotes a distance between a top-dead center and a bottom-dead center of the plunger in the top-to-bottom direction, and r denotes a radius of the roller.

### BRIEF DESCRIPTION OF THE DRAWINGS

FIG. 1 is a schematic cross-sectional view of a fuel supply pump according to an embodiment of the present disclosure;

FIG. 2 is an enlarged partial schematic cross-sectional view of the fuel supply pump of the embodiment, showing a tappet of the fuel supply pump;

FIG. 3 is an enlarged partial schematic cross-sectional view of the fuel supply pump of the embodiment, showing a recontact state of a roller to a non-slide surface;

FIG. 4 is an enlarged partial schematic cross-sectional view of a modification of the fuel supply pump, showing the tappet of the fuel supply pump;

FIG. 5A is a descriptive view showing an excessively decentered state of a roller, which has fallen down from a shoe, in a related art;

FIG. 5B is a descriptive view showing a turned state of the roller, which has fallen from the shoe, in the related art shown in FIG. 5A;

FIGS. 6A and 6B are descriptive views showing one manufacturing method in a related art; and

FIGS. 6C and 6D are descriptive views showing another manufacturing method in another related art, which is different from the manufacturing method of FIGS. 6A and 6B.

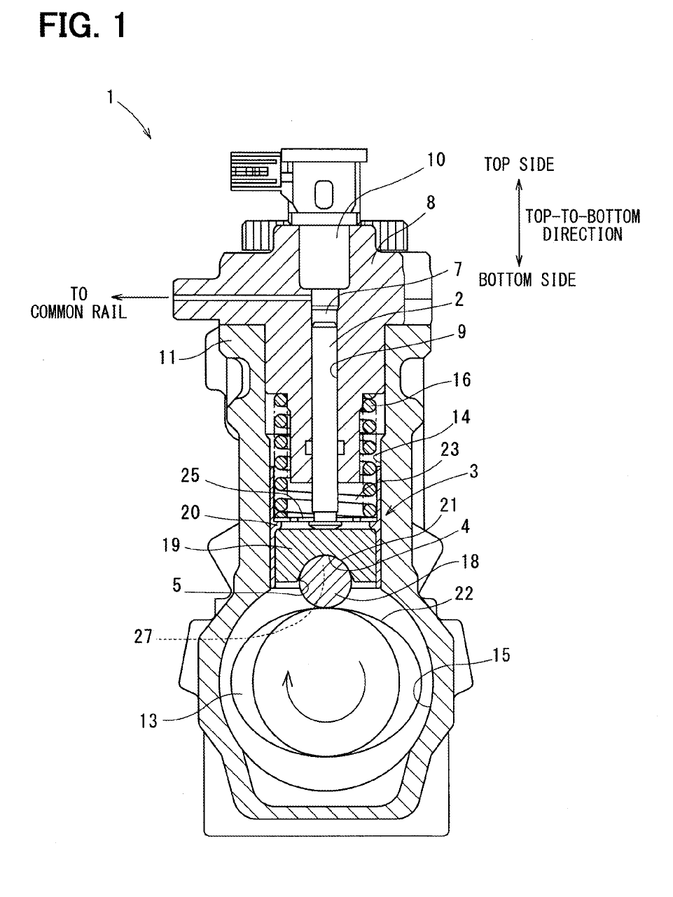

### DETAILED DESCRIPTION

An embodiment of the present disclosure will be described with reference to the accompanying drawings.

First of all, a structure of a fuel supply pump 1 according to the present embodiment will be described with reference to the accompanying drawings. In the accompanying drawings, the top side may be also referred to as the upper side, and the bottom side may be also referred to as the lower side.

The fuel supply pump 1 pressurizes fuel to a high pressure, which is higher than 100 Mpa, and discharges the pressurized fuel. For example, the fuel supply pump 1 is applied to a fuel supply system that supplies the fuel from an accumulator (common rail), which accumulates the fuel in the high pressure state, to an internal combustion engine (not shown). The fuel supply pump 1 is controlled by an undepicted electronic control unit (ECU).

The fuel supply pump 1 includes a plunger 2, a tappet 3, a partially cylindrical surface 4, non-slide surfaces (also referred to as guide surfaces) 5 and first to third relationships.

The plunger 2 forms a pressurizing chamber 7 of fuel and is reciprocated in a top-to-bottom direction to increase or decrease a volume of the pressurizing chamber 7. Furthermore, the plunger 2 is received in a cylinder 9 formed in a cylinder body 8 such that an axial direction of the plunger 2 coincides with the top-to-bottom direction. The plunger 2 slidably contacts an inner peripheral surface of the cylinder 9. The plunger 2 is supported in a slidable manner in the top-to-bottom direction in the cylinder 9. The plunger 2 is received in the cylinder 9, so that a lower end of the pressurizing chamber 7 is defined by the plunger 2. When the plunger 2 is moved upward, the volume of the pressurizing chamber 7 is reduced. In contrast, when the plunger 2 is moved downward, the volume of the pressurizing chamber 7 is increased.

An upper end of the pressurizing chamber 7 is defined by a control valve 10, which is electronically controlled by a command outputted from the ECU.

Furthermore, the pressurizing chamber 7 is communicated with the common rail through a check valve (not shown) on a downstream side of the pressurizing chamber 7. Also, the pressurizing chamber 7 is communicated with an outlet of a feed pump (not shown) through the control valve 10 on an upstream side of the pressurizing chamber 7. Here, the feed pump is rotated by, for example, the internal combustion engine through a camshaft (not shown) described later. The feed pump suctions fuel from the fuel tank and supplies the drawn fuel into the pressurizing chamber 7 through the control valve 10.

The control valve 10 meters the fuel, which is discharged from the pressurizing chamber 7 toward the common rail. The control valve 10 is controlled by the ECU and is operated in the following manner.

Specifically, in a state where the plunger 2 is moved upward to reduce the volume of the pressurizing chamber 7, when a valve closing command is outputted from the ECU to the control valve 10, the control valve 10 is closed. Thereby, the fuel pressure in the pressurizing chamber 7 is increased, and the check valve (not shown) is opened. Thus, the fuel is discharged from the pressurizing chamber 7 to the common rail.

Thereafter, when a valve opening command is outputted from the ECU to the control valve 10, the control valve 10 is opened. Thereby, the fuel pressure in the pressurizing chamber 7 is reduced, and the check valve is closed. Thus, the discharge of fuel from the pressurizing chamber 7 to the common rail is terminated. Furthermore, in the state where the plunger 2 is moved downward to increase the volume of the pressurizing chamber 7, the control valve 10 is closed, and the fuel, which is discharged from the feed pump, is drawn into the pressurizing chamber 7.

An assembly (unit) of the plunger 2, the cylinder body 8 and the control valve 10 is installed and is integrated to a housing 11 of the fuel supply pump 1 with screws.

The tappet 3 is a mechanism, which converts rotational motion of a cam 13 placed on a lower side of the plunger 2 into linear reciprocating motion and transmits the converted linear reciprocating motion to the plunger 2. The tappet 3 is received in a receiving hole 14 of the housing 11 and is interposed between the plunger 2 and the cam 13.

The cam 13 and the camshaft are received in a cam chamber 15 formed at a lower side of the receiving hole 14 in the housing 11 and is rotated by the internal combustion engine.

The cam 13 is rotated by a torque applied from the internal combustion engine, so that the plunger 2 is driven upward by the cam 13 through the tappet 3. Furthermore, a spring 16 extends in the top-to-bottom direction and is placed between the cylinder body 8 and the plunger 2 as well as the tappet 3. The spring 16 downwardly urges the plunger 2 and the tappet 3. Therefore, when the plunger 2 is moved upward, the plunger 2 can be returned downward by the urging force of the spring 16.

Furthermore, the tappet 3 includes a roller 18, a shoe 19 and a tappet body 20, which will be described below.

The roller 18 is configured into a cylindrical form. The roller 18 is reciprocated in the top-to-bottom direction in a state where the roller 18 contacts an outer peripheral surface 22 of the cam 13 and rotates along the outer peripheral surface 22 of the cam 13. The shoe 19 rotatably supports the roller 18 and is reciprocated in the top-to-bottom direction.

The tappet body 20 forms an outer shell of the tappet 3. The tappet body 20 has an inside space 23, which is configured into a tubular form and opens on a lower side and an upper side of the inside space 23. The shoe 19 is press fitted into the lower side of the inside space 23. A lower portion of the plunger 2, which projects downward from the cylinder body 8, is inserted into the upper side of the inside space 23 and contacts an upper surface of the shoe 19.

Furthermore, a flange 24 is formed in the tappet body 20 such that the flange 24 radially inwardly projects into the inside space 23. The shoe 19 is press fitted to the lower side of the flange 24. A seat 25 is placed on the upper side of the flange 24. The seat 25 forms a spring seat, which is placed at the lower end of the spring 16 to support the lower end of the spring 16. The spring 16 can integrally downwardly urge the plunger 2 and the tappet 3.

Furthermore, the shoe 19 and the tappet body 20 are configured into a cylindrical form, which has a central axis that is parallel to the top-to-bottom direction. Thus, a rotation limiting element (not shown) is press fitted to the tappet body 20 such that the rotation limiting element radially outwardly projects. A slide groove (not shown) is formed in an inner peripheral wall of the receiving hole 14 to slidably receive the rotation limiting element. Therefore, the tappet 3 is guided by the rotation limiting element and is reciprocated in the top-to-bottom direction.

The fuel supply pump 1 is formed as an inline pump that has a plurality of pump units, each of which includes the plunger 2, the tappet 3 and the cam 13, and these pump units are arranged one after another in an axial direction of the camshaft.

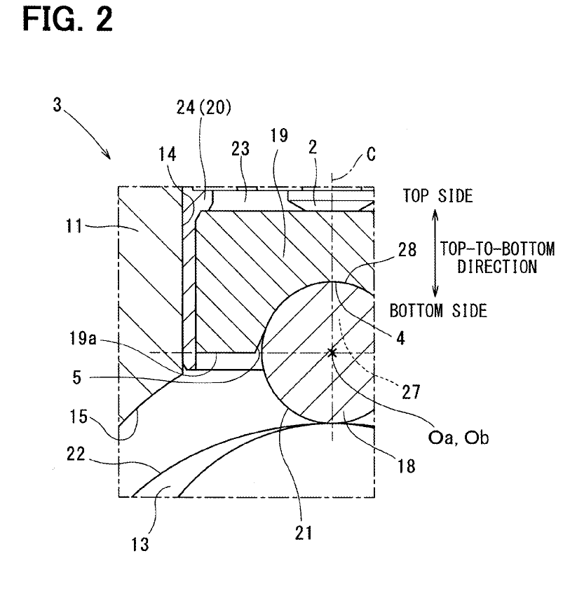

The partially cylindrical surface 4 is a slide surface, which is formed in the shoe 19 and slidably contacts a cylindrical surface 21 of the roller 18 from an upper side of the roller 18 to rotatably support the roller 18. Specifically, the partially cylindrical surface 4 is recessed upward away from a lower end surface of the shoe 19, and a space, which is formed by the partially cylindrical surface 4, opens downward. The space, which is formed by the partially cylindrical surface 4, forms a fitting space 27, into which the roller 18 is fitted. A rotational axis Oa of the roller 18 extends perpendicular to a central axis C of the plunger 2, as shown in FIG. 2.

Furthermore, in a cross section (e.g., a plane of FIG. 2), which is perpendicular to the rotational axis Oa of the roller 18, the partially cylindrical surface 4 forms or is seen as an arc (hereinafter also referred to as a slidably contacting arc) 28, which is arcuately curved about the rotational axis Oa of the roller 18 and has a radius that is generally the same as a radius of the roller 18, and the arc 28 is placed on an upper side of the rotational axis Oa of the roller 18. In other words, a radius of curvature of the arc 28 of the partially cylindrical surface 4 is generally the same as a radius of curvature of the cylindrical surface 21 of the roller 18. The partially cylindrical surface 4 is configured such that a central angle of the slidably contacting arc 28 is less than 180 degrees. Furthermore, the partially cylindrical surface 4 is mirror-symmetrical about the central axis C of the plunger 2 and a central axis Ob of the partially cylindrical surface 4.

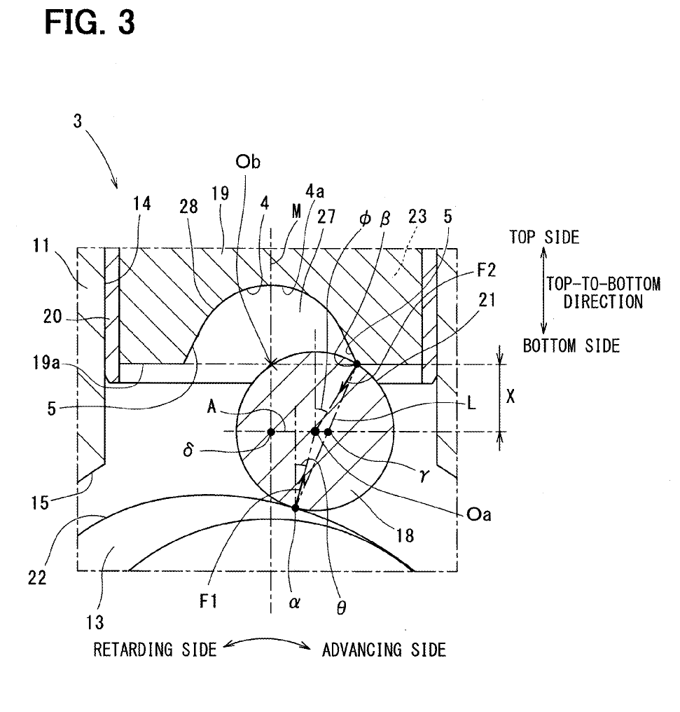

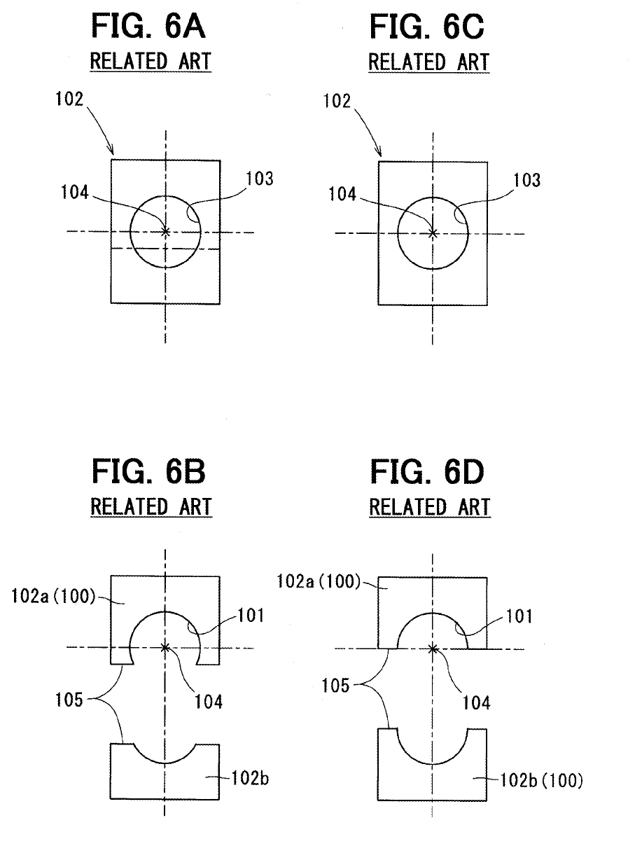

In this way, the shoe 19 can be formed without wasting the material of the shoe (see FIGS. 6C, 6D). However, for example, in a case where the tappet body 20 is fastened to, i.e., is stuck to the housing 11 and is stopped at the top dead center, the roller 18 falls down from the fitting space 27 (see FIG. 3). Therefore, according to the present embodiment, the first to third relationships are set. Thereby, even in the case where the roller 18 falls down, the rotation of the camshaft is enabled to avoid the stopping of the internal combustion engine.

A film (coating) 4a, which is made of diamond or diamond-like carbon, is formed on the partially cylindrical surface 4, so that a coefficient of kinetic friction of the partially cylindrical surface 4 relative to the cylindrical surface 21 is reduced.

In the present embodiment, the number of the non-slide surfaces (the guide surfaces) 5 is two, and these non-slide surfaces 5 are integrally formed in the shoe 19 such that the non-slide surfaces 5 continuously seamlessly extend from the partially cylindrical surface 4. Specifically, in the present embodiment, each non-slide surface 5 is formed as a planar surface and continuously downwardly extends from the partially cylindrical surface 4 on a lower side of the partially cylindrical surface 4. The non-slide surface 5 does not slidably contact the cylindrical surface 21 of the roller 18 during the normal operation, in which the roller 18 is kept in contact with the partially cylindrical surface 4. With reference to FIG. 2, in a cross section that is perpendicular to the rotational axis Oa of the roller 18, the non-slide surface 5 is seen as a straight line, which is placed on an upper side of the rotational axis Oa of the roller 18. Specifically, the non-slide surface 5 downwardly extends as a planar surface from the corresponding lower end of the partially cylindrical surface 4 such that a distance between the non-slide surface 5 and the cylindrical surface 21 increases toward the lower side of the non-slide surface 5 (i.e., toward a lower end of the non-slide surface 5, which is opposite from the partially cylindrical surface 4 in a circumferential direction of the partially cylindrical surface 4), as shown in FIG. 2.

Furthermore, the lower end of the non-slide surface 5 is included in the lower end surface (bottom end surface) 19a of the shoe 19. The lower end surface 19a of the shoe 19 and the central axis Ob of the partially cylindrical surface 4 can be included in a common plane (see FIG. 2). Therefore, the lower end of the non-slide surface 5 forms an opening edge of the fitting space 27. Furthermore, the non-slide surface 5 is provided at the two locations, which are mirror-symmetrical about the central axis C of the plunger 2 and the central axis Ob of the partially cylindrical surface 4.

According to the first relationship, there is satisfied the following inequality 1 with respect to a reciprocation distance X of the plunger 2 in the top-to-bottom direction (i.e., a distance between a top-dead center and a bottom-dead center of the plunger 2 in the top-to-bottom direction) and a radius r of the roller 18 (see FIG. 3).

X<r Inequality 1

The second relationship is a positional relationship that is achieved in a recontact state of the roller 18, in which the roller 18 contacts the shoe 19 when the roller 18 is pushed and lifted upward by the cam 13 upon reaching of the bottom dead center of the roller 18 after falling down of the roller 18 from the shoe 19 apart from the partially cylindrical surface 4 at the top dead center of the shoe 19 in an imaginary state where the shoe 19 is stopped in the top dead center (while the cam 13 being kept rotated). According to the second relationship, the rotational axis Oa of the roller 18 is present (i.e., placed) between an intersection point y and an intersection point δ in a plane A in the recontact state of the roller 18 shown in FIG. 3. The intersection point γ is between the plane A and a line segment L. That is, the plane A and the line segment L intersect with each other at the intersection point γ. The intersection point δ is between the plane A and a straight line M. That is, the plane A and the straight line M intersect with each other at the intersection point δ. The line segment L connects between a contact point a and a contact point β. The contact point α is between the cam 13 and the roller 18 in the recontact state shown in FIG. 3. In other words, the cam 13 and the roller 18 contact with each other at the contact point α in the recontact state shown in FIG. 3. The contact point β is between the roller 18 and the shoe 19 in the recontact state shown in FIG. 3. In other words, the roller 18 and the shoe 19 contact with each other at the contact point β in the recontact state shown in FIG. 3. The plane A is perpendicular to the top-to-bottom direction and includes the rotational axis Oa of the roller 18 in the recontact state shown in FIG. 3. The straight line M is perpendicular to the central axis Ob of the partially cylindrical surface 4 (also serving as a central axis of the fitting space 27) and is parallel to the top-to-bottom direction.

Furthermore, in the recontact state, the rotational axis Oa of the roller 18 does not coincide with the central axis Ob of the partially cylindrical surface 4 (i.e., the central axis of the fitting space 27) and is deviated from the central axis Ob of the partially cylindrical surface 4 on the lower side of the central axis Ob and on the advancing side (the right side in FIG. 3) of the central axis Ob. The contact point β is formed in the lower end of one of the two non-slide surfaces 5, which is located on the advancing side (the right side in FIG. 3) and contacts with the cylindrical surface 21 of the roller 18 when the roller 18 is pushed and lifted upward by the cam 13.

The third relationship is a positional relationship that is satisfied in the recontact state upon satisfaction of the second relationship. With reference to FIG. 3, according to the third relationship, there is satisfied the following inequality 2 with respect an angle θ, an angle φ and a coefficient μ of kinetic friction. The angle θ is formed between the top-to-bottom direction and a normal direction, which is normal to the cylindrical surface 21 at the contact point α. The angle φ is formed between the top-to-bottom direction and a normal direction, which is normal to the cylindrical surface 21 at the contact point β. The coefficient μ of kinetic friction is a coefficient of kinetic friction at the contact point β.

sin(φ−θ)·cosφ/cosθ>μ Inequality 2

Here, in order to move the roller 18 in the recontact state toward the fitting space 27, the following conditional expression 1 must be satisfied when an abutment force (contact force) F1, which is applied from the cam 13 to the roller 18 at the contact point α, and an abutment force (contact force) F2, which is applied from the non-slide surface 5 to the roller 18 at the contact point β, are used.

sin(φ−θ)·F1>μ·F2 Conditional Expression 1

Furthermore, the following conditional expression 2 is satisfied because of the force balance in the top-to-bottom direction in the recontact state.

F1·cosθ=F2·(cosφ+μ·sinφ) Conditional Expression 2

The inequality 2 is obtained by deleting the abutment force F1 and the abutment force F2 from the conditional expressions 1 and 2.

Now, advantages of the present embodiment will be described.

In the fuel supply pump 1 of the present embodiment, the partially cylindrical surface 4 is a slide surface that is formed in the shoe 19 and slidably contacts the cylindrical surface 21 of the roller 18 from the upper side of the roller 18 to rotatably support the roller 18. The arc 28 is placed on the upper side of the rotational axis Oa of the roller 18, and the central angle of the arc 28 is less than 180 degrees. According to the first relationship, the inequality 1 is satisfied.

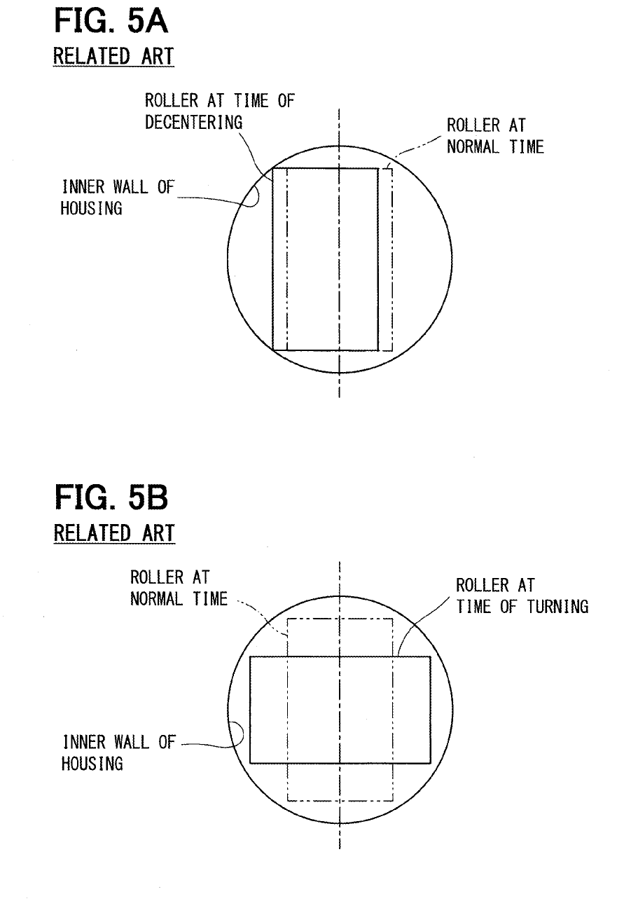

Thereby, even when the roller 18 falls down from the shoe 19, the non-slide surface 5 can limit the excessive decentering of the roller 18 and the turning of the roller 18 (see FIGS. 5A and 5B) to limit the contact of the corner of the roller 18 to the inner wall of the housing 11. Therefore, even when the falling down of the roller 18 occurs, the rotation of the camshaft is enabled to avoid the stopping of the internal combustion engine.

Furthermore, in the fuel supply pump 1, the second relationship is the positional relationship in the recontact state. According to the second relationship, the rotational axis Oa of the roller 18 is present between the intersection point γ and the intersection point δ in the plane A.

Thereby, a resultant force of the abutment force F1 and the abutment force F2 acts against the roller 18 in a fitting direction, which is a direction for fitting the roller 18 into the fitting space 27. Therefore, even in the case where the roller 18 falls down from the shoe 19, the roller 18 can be refitted into the fitting space 27. Thus, the rotation of the camshaft can be more reliably maintained to avoid the stopping of the internal combustion engine.

Furthermore, in the fuel supply pump 1, the third relationship is the positional relationship in the recontact state. According to the third relationship, the inequality 2 is satisfied.

Thereby, when the angles θ, φ and the coefficient μ of kinetic friction are set to satisfy the inequality 2, it is possible to provide the fuel supply pump 1, which can maintain the rotation of the camshaft even in the imaginary state in view of the coefficient μ of kinetic friction.

Furthermore, in the fuel supply pump 1, the non-slide surface 5 continuously downwardly extends from the partially cylindrical surface 4 on the lower side of the partially cylindrical surface 4 and does not slidably contact the cylindrical surface 21 of the roller 18. In the cross section that is perpendicular to the rotational axis Oa of the roller 18, the non-slide surface 5 is seen as the straight line, which is placed on the upper side of the rotational axis Oa of the roller 18, as shown in FIG. 3.

In this way, the lower end of the non-slide surface 5 becomes the opening edge of the fitting space 27. Therefore, the opening edge of the fitting space 27 does not slidably contact the cylindrical surface 21. Thus, even when the deviation occurs between the central axis Ob of the partially cylindrical surface 4 and the rotational axis Oa of the roller 18, the roller 18 does not engage the opening edge of the fitting space 27 and can be rotated.

Now, modifications of the embodiment will be described.

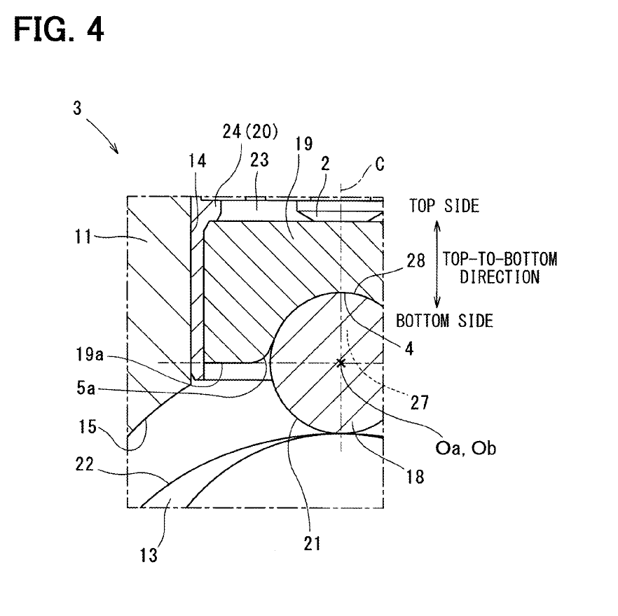

In the fuel supply pump 1 of the above embodiment, the non-slide surface 5 is seen as the straight line, which is located on the upper side of the rotational axis Oa of the roller 18, in the cross section that is perpendicular to the rotational axis Oa of the roller 18. Alternatively, as shown in FIG. 4, in place of the non-slide surface 5, a non-slide surface (guide surface) 5a, which is formed as a curved surface, may be provided. Specifically, the non-slide surface 5a is formed such that the non-slide surface 5a is seen as a curved line, which is located on the upper side of the rotational axis Oa of the roller 18, in the cross section that is perpendicular to the rotational axis Oa of the roller 18, in the normal operational state shown in FIG. 4. In FIG. 4, the curved line of the non-slide surface 5a is convex toward the roller 18. Alternatively, the curved line of the non-slide surface 5a may be concaved away from the roller 18. In such a case, for example, the non-slide surface 5a may be formed as an arcuate surface, which is concaved away from the roller 18 and has a radius of curvature that is larger than the radius of curvature of the arc 28 of the partially cylindrical surface 4. In addition, the non-slide surface 5 of the above embodiment may be modified to include a combination of the planar surface and the curved surface. Also, the curved surface of the non-slide surface is not necessarily the arcuate surface and can be any type of curved surface.

Furthermore, in the fuel supply pump 1 of the above embodiment, the cylindrical surface 21 of the roller 18 contacts the lower end of the non-slide surface 5, and thereby the contact point 13 is formed in the lower end of the non-slide surface 5. Alternatively, the non-slide surface 5 may be eliminated. In such a case, the cylindrical surface 21 of the roller 18 may contact a lower end of the partially cylindrical surface 4, and thereby the lower end of the partially cylindrical surface 4 forms the contact point β.

Furthermore, in the above embodiment, the central angle of arc 28 of the partially cylindrical surface 4 is set to be less than 180 degrees. Alternatively, the central angle of the arc 28 of the partially cylindrical surface 4 may be set to be equal to 180 degrees, if desired. In such a case, the non-slide surfaces 5, 5a may extend on the lower side of the central axis Oa of the roller 18 in the state shown in FIG. 2 or FIG. 4.

What is claimed is:

1. A fuel supply pump comprising:
a plunger that forms a pressurizing chamber of fuel and is reciprocated in a top-to-bottom direction to increase or decrease a volume of the pressurizing chamber;
a tappet that is a mechanism, which converts rotational motion of a cam placed on a lower side of the plunger into linear reciprocating motion and transmits the converted linear reciprocating motion to the plunger, wherein the tappet includes:
a roller that is configured into a cylindrical form, wherein the roller is reciprocated in the top-to-bottom direction in a state where the roller contacts an outer peripheral surface of the cam and rotates along the outer peripheral surface of the cam; and
a shoe that rotatably supports the roller and is reciprocated in the top- to-bottom direction; and
a partially cylindrical surface that is a slide surface, which is formed in the shoe and slidably contacts a cylindrical surface of the roller from an upper side of the roller to rotatably support the roller, wherein in a cross section, which is perpendicular to a rotational axis of the roller, the partially cylindrical surface forms an arc, which is arcuately curved about the rotational axis of the roller and has a radius that is generally the same as a radius of the roller, and the arc is placed on an upper side of the rotational axis of the roller, wherein there is satisfied a first relationship that is an inequality of X<r
where:
X denotes a distance between a top-dead center and a bottom-dead center of the plunger in the top-to-bottom direction; and
r denotes a radius of the roller.

2. The fuel supply pump according to claim 1, wherein:
the roller contacts the shoe in a recontact state when the roller is pushed and lifted upward by the cam upon reaching of a bottom dead center of the roller after falling down of the roller from the shoe apart from the partially cylindrical surface at a top dead center of the shoe in an imaginary state where the shoe is stopped in the top dead center; and
in the recontact state of the roller with the shoe upon the pushing and lifting of the roller by the cam after reaching of the bottom dead center of the roller in the imaginary state, there is satisfied a second relationship with respect to:
a contact point between the cam and the roller;
a contact point between the roller and the shoe;
a line segment that connects between the contact point, which is between the cam and the roller, and the contact point, which is between the roller and the shoe;
a plane that is perpendicular to the top-to-bottom direction and includes the rotational axis of the roller;
an intersection point that is between the plane and the line segment;
a straight line that is perpendicular to a central axis of the partially cylindrical surface and is parallel to the top-to-bottom direction; and
an intersection point that is between the plane and the straight line; and
the second relationship is that the rotational axis of the roller is present between the intersection point, which is between the plane and the line segment, and the intersection point, which is between the plane and the straight line, in the plane.

3. The fuel supply pump according to claim 2, wherein in the recontact state of the roller with the shoe, there is satisfied a third relationship that is an inequality of sin(φ−θ)·cosφ/cosθ>μ
where:
θ denotes an angle that is formed between the top-to-bottom direction and a normal direction, which is normal to the cylindrical surface at the contact point between the cam and the roller;
φ denotes an angle that is formed between the top-to-bottom direction and a normal direction, which is normal to the cylindrical surface at the contact point between the roller and the shoe; and
μ denotes a coefficient of kinetic friction at the contact point between the roller and the shoe.

4. The fuel supply pump according to claim 1, comprising a non-slide surface, which is formed in the shoe and continuously downwardly extends from the partially cylindrical surface on a lower side of the partially cylindrical surface, wherein:
the non-slide surface does not slidably contact the cylindrical surface of the roller; and
in the cross section that is perpendicular to the rotational axis of the roller, the non-slide surface is seen as a curved line or a straight line, which is placed on an upper side of the rotational axis of the roller.

5. The fuel supply pump according to claim 1, wherein a film, which reduces a coefficient of kinetic friction of the partially cylindrical surface, is formed in the partially cylindrical surface.

6. The fuel supply pump according to claim 5, wherein the film is made of diamond or diamond like carbon.

7. The fuel supply pump according to claim 1, comprising a housing, which receives the tappet and the cam, wherein:
the tappet includes a tappet body, which is guided by the housing and is reciprocated in the top-to-bottom direction; and
the shoe is press fitted into the tappet body.

8. The fuel supply pump according to claim 1, comprising a non-slide surface, which is formed in the shoe and continuously downwardly extends from the partially cylindrical surface on a lower side of the partially cylindrical surface, wherein in a state where the cylindrical surface of the roller contacts the partially cylindrical surface, a distance between the non-slide surface and the cylindrical surface of the roller increases toward an end of the non-slide surface, which is opposite from the partially cylindrical surface in a circumferential direction of the partially cylindrical surface, in the cross section that is perpendicular to the rotational axis of the roller.

9. The fuel supply pump according to claim 1, wherein a central angle of the arc of the partially cylindrical surface is less than 180 degrees.
